(19) United States
(12) Patent Application Publication
(10) Pub. No.: US 2007/0042817 A1
(43) Pub. Date: Feb. 22, 2007

(54) Ergonomic mobile device

(75) Inventor: Ying Shi Lin, Taipei City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/432,140

(22) Filed: May 11, 2006

(30) Foreign Application Priority Data
May 12, 2005 (TW) 94115380

(51) Int. Cl. H04M 1/00

(52) U.S. Cl. 455/575.1; 211/35

(57) ABSTRACT

An ergonomic mobile device. The mobile device comprises a main portion and a sliding portion. The main portion comprises a first sloped surface. The sliding portion, slidably connected to the main portion, comprises an upper surface and a second sloped surface. The first sloped surface faces the second sloped surface and is connected thereto in parallel. When the sliding portion is closed on the main portion, the first sloped surface covers the second sloped surface. When the sliding portion is pushed, the first sloped surface and the upper surface form a predetermined angle.

### BACKGROUND

The invention relates to a mobile device with a sliding portion, and in particular to an ergonomic mobile device.

With the rapid progress in mobile device design, various mobile phone styles, such as bar, foldable and push-up phones, high quality communication, simple operation, camera, low-power consumption, large size screen, and thin and small features are considered as the requirements.

In FIGS. 1A and 1B, a push-up phone 10 comprises a sliding part 11, a main part 12, a screen 13, a first key part 15 and a second key part 14. The sliding part 11 is slidably disposed on the main part 12 by rails (not shown in Figs.). The screen 13 and the second key part 14 are disposed on the sliding part 11, and the first key part 15 is disposed on the main part 12.

When the main part 12 is fully covered by the sliding part 11, i.e., the first key part 15 is hidden beneath of the sliding part 11, the user can control the second key part 14 to answer a phone call. When the sliding part 11 is pushed up to reveal the first key part 15, the user can dial the number by the first key part 15.

Because the sliding part 11 and the main part 12 has a distinct thickness and the direction of the sliding part 11 sliding from the main part 12 parallel to the surface of the screen 13, however, a differential H is formed between the second key part 14 and the first key part 15. Owing to differential H, a user face cannot comfortably rest against the phone 10.

### SUMMARY

The invention provides a thin, light and ergonomic mobile device to facilitate user operation of a key portion.

The ergonomic mobile device comprises a main portion and a sliding portion. The main portion has a first sloped surface. The sliding portion, relatively slidably connected to the main portion, has an upper surface and a second sloped surface facing the first sloped surface in parallel. The first sloped surface and the upper surface form a predetermined angle less than 180 degrees when the sliding portion is pushed.

The sliding portion has a screen disposed on the upper surface. The predetermined angle is greater than 90 degrees, and the main portion and the sliding portion form a V-shaped structure. The main portion further comprises a first key portion disposed on the first sloped surface. The sliding portion further comprises a second key portion disposed on the upper surface. The sliding portion further comprises a guide rail disposed on the second sloped surface and the main portion further comprises a slot disposed on the first sloped surface, wherein the guide rail is movably disposed in the slot.

The main portion further comprises a guide rail disposed on the first sloped surface and the sliding portion further comprises a slot disposed on the second sloped surface, wherein the guide rail is movably disposed in the slot.

In a preferred embodiment, an ergonomic mobile device comprises a main portion and a sliding portion having a screen. The sliding portion connected to the main portion is slidable with respect to the main portion. The first sloped surface and the upper surface form a predetermined angle less than 180 degrees when the sliding portion is pushed.

### DESCRIPTION OF THE DRAWINGS

The invention can be more fully understood by reading the subsequent detailed description and examples with references made to the accompanying drawings, wherein:

FIG. 1A is a schematic view of a conventional mobile phone;

FIG. 1B is a schematic view showing the mobile phone in operative mode;

FIG. 2A is a schematic view of an ergonomic mobile device of the first embodiment of the invention;

FIG. 2B is a side view of the ergonomic mobile device of FIG. 2A;

FIG. 3A is a schematic view of the ergonomic mobile device of the invention when a sliding portion thereof is pushed;

FIG. 3B is a side view of the ergonomic mobile device of FIG. 3A;

FIG. 4A is an exploded side view of the ergonomic mobile device of the first embodiment of the invention; and

FIG. 4B is an exploded side view of an ergonomic mobile device of the second embodiment of the invention.

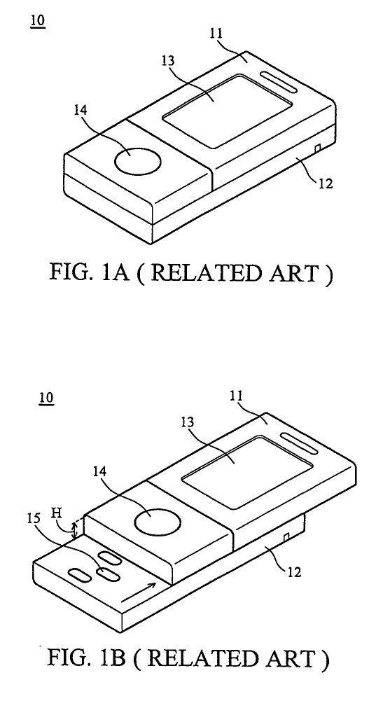

### DETAILED DESCRIPTION

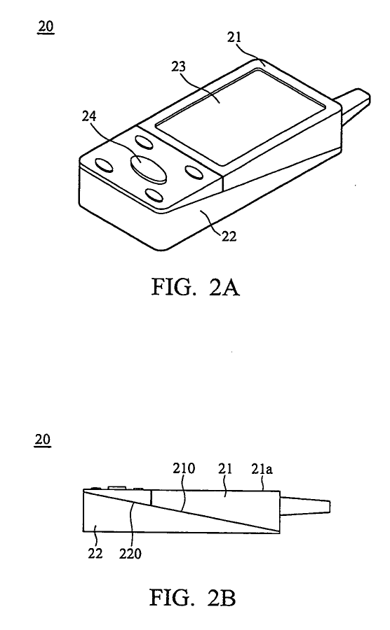

In FIGS. 2A and 2B, an ergonomic mobile device 20 of the first embodiment of the invention comprises a sliding portion 21 and a main portion 22. The main portion 22 comprises a first sloped surface 220 and a first key portion 25 (e.g. numerical key portion) disposed on the first sloped surface 220. The sliding portion 21 comprises an upper surface 21a, a second sloped surface 210 opposite to the upper surface 21a, a screen 23 disposed on the upper surface 21a and a second key portion 24 disposed on the upper surface 21a. The second key portion 24 is a functional key portion, and the sliding portion 21 connected to the main portion 22 is slidable with respect to the main portion 22.

When the sliding portion 21 is connected to the main portion 22, the first sloped surface 220 faces the second sloped surface 210 and is connected thereto in parallel. When the sliding portion 21 is closed on the main portion 22, the second key portion 24 can be operated and the first sloped surface covers the second sloped surface.

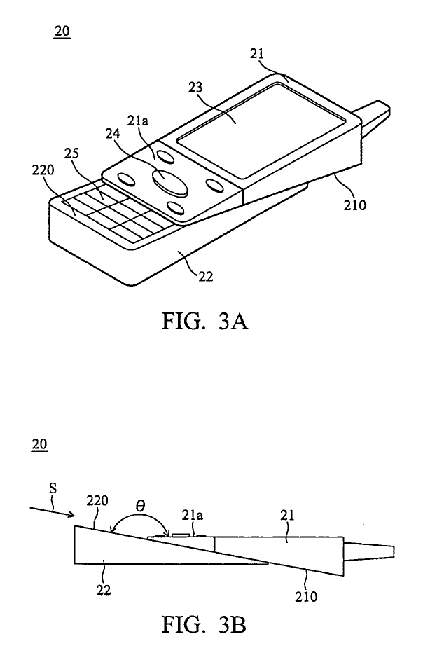

In FIGS. 3A and 3B, when the sliding portion 21 is pushed away from the main portion, the first sloped surface 220 is partially covered by the second sloped surface 210 and the first key portion 25 is exposed. Thus, the second key portion 24 and the first key portion 25 can be operated. The first sloped surface 220 and the upper surface 21a form a predetermined angle θ ranging from about 90 to 180 degrees. The predetermined angle θ is ergonomically designed according to an angle between a user's cheek and ear. That is to say, the main portion 22 and the sliding portion 21 form the predetermined angle θ, thus, the sliding portion 21 moves along a direction S of FIG. 3B. The main portion 22 and the sliding portion 21 form a substantially V-shaped structure.

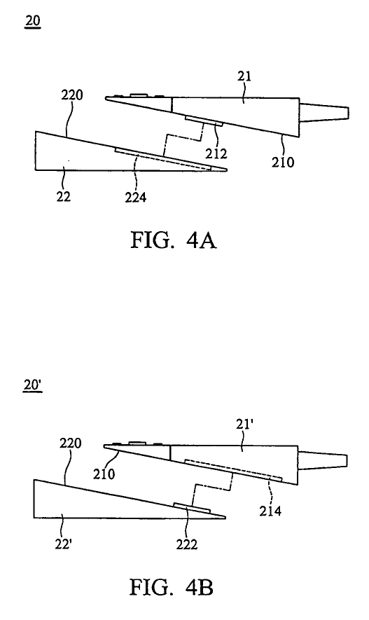

In FIG. 4A, the sliding portion 21 comprises a guide rail 212 disposed on the second sloped surface 210 and the main portion 22 comprises a slot 224 disposed on the first sloped surface 220. The guide rail 212 is movably disposed in the slot 224. The guide rail 212 and the slot 224 form a guiding mechanism to cause the sliding portion 21 to slidably connect to the main portion 22.

In FIG. 4B, a mobile device 20′ of the second embodiment of the invention comprises a main portion 22′ and a sliding portion 21′. The mobile device 20′ differs from the mobile device 20 of the first embodiment in that the guide rail and the slot are alternately arranged, i.e., a guide rail 222 is formed on the main portion 22′ and a slot 214 is formed on the sliding portion 21′. When the guide rail 222 is connected to the slot 214, the sliding portion 21′ can be movably disposed on the main portion 22′. It is to be understood that the invention is not limited to the disclosed embodiments of the assembly method. Any sliding rails or connecting mechanisms can be applied on the main portion and the sliding portion.

Note that the predetermined angle formed between the first sloped surface 220 of the main portion 22 leaves no differential formed between the surfaces of the first and second key portions of the mobile device 20 or 20′ when dialing. The mobile device 20 or 20′ having an optimum geometric key location can be operated as a bar phone, and the user's face can comfortably rest against the upper surface 21a of the sliding portion 21 of the mobile device 20. Thus, the mobile device 20 and 20′ can be operated simply and the manufacturing cost can be reduced.

While the invention has been described with respect to preferred embodiment, it is to be understood that the invention is not limited thereto, but, on the contrary, is intended to accommodate various modifications and equivalent arrangements included within the spirit and scope of the appended claims.

What is claimed is:

1. An ergonomic mobile device, comprising:
a main portion comprising a first sloped surface; and
a sliding portion relatively slidably connected to the main portion, comprising an upper surface and a second sloped surface facing the first sloped surface in parallel, wherein the first sloped surface and the upper surface form a predetermined angle less than 180 degrees when the sliding portion is pushed away from the main portion.

2. The ergonomic mobile device as claimed in claim 1, wherein the sliding portion further comprises a screen disposed on the upper surface.

3. The ergonomic mobile device as claimed in claim 1, wherein the predetermined angle is greater than 90 degrees.

4. The ergonomic mobile device as claimed in claim 1, wherein the main portion and the sliding portion substantially form a V-shaped structure.

5. The ergonomic mobile device as claimed in claim 1, wherein the main portion further comprises a first key portion disposed on the first sloped surface.

6. The ergonomic mobile device as claimed in claim 1, wherein the sliding portion further comprises a second key portion disposed on the upper surface.

7. The ergonomic mobile device as claimed in claim 1, wherein the sliding portion further comprises a guide rail disposed on the second sloped surface and the main portion further comprises a slot disposed on the first sloped surface, wherein the guide rail is movably disposed in the slot.

8. The ergonomic mobile device as claimed in claim 1, wherein the main portion further comprises a guide rail disposed on the first sloped surface and the sliding portion further comprises a slot disposed on the second sloped surface, wherein the guide rail is movably disposed in the slot.

9. An ergonomic mobile device, comprising:
a main portion; and
a sliding portion comprising a screen and relatively slidably connected to the main portion, wherein the first sloped surface and the upper surface form a predetermined angle less than 180 degrees when the sliding portion is pushed away from the main portion.

10. The ergonomic mobile device as claimed in claim 9, wherein the predetermined angle is greater than 90 degrees.

11. The ergonomic mobile device as claimed in claim 1, wherein the sliding portion further comprises a guide rail and the main portion further comprises a slot, wherein the guide rail is movably disposed in the slot.

12. The ergonomic mobile device as claimed in claim 9, wherein the main portion further comprises a guide rail and the sliding portion further comprises a slot, wherein the guide rail is movably disposed in the slot.
